(19) United States
(12) Patent Application Publication
(10) Pub. No.: US 2010/0276439 A1
(43) Pub. Date: Nov. 4, 2010

(54) Container

(75) Inventor: Martin Price, Osbaston (GB)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: The Haigh Engineering Company Ltd., Hereford (GB)

(21) Appl. No.: 12/766,467

(22) Filed: Apr. 23, 2010

(30) Foreign Application Priority Data
Apr. 23, 2009 (GB) 0906985.7

(51) Int. Cl. E05C 3/06; E05B 1/00; B65D 43/16

(52) U.S. Cl. 220/833; 292/200

(57) ABSTRACT

A container (20) having an opening, a lid (10) pivotally mounted on the container (2) and movable to open and close the opening, a lid latch assembly (100) mounted on the lid (8), the lid latch assembly (100) and container (2) having cooperating engagement portions by which the lid (10) can be held while the opening in the container (2) is closed, the lid latch assembly (100) having a handle (114) by which the lid (10) can be manually pivoted to engage the cooperating engagement portions whilst storing energy in a spring (126) in the lid latch assembly (100), the handle (114) being manually moveable to cause the cooperating engagement portions to disengage and so allow the lid (10) to move to open the opening and an electrical solenoid (121) which can be activated to cause the cooperating engagement means to disengage under the action of the spring (126) in which energy was stored on closing the lid (10). The present invention provides a container with a lid latch assembly which is electrically operable and which can also be manually opened if required or preferred.

### RELATED APPLICATION

This application claims priority under 35 U.S.C. §119 or 365 to Great Britain Application No. 0906985.7, filed Apr. 23, 2009. The entire teachings of the above application are incorporated herein by reference.

### BACKGROUND OF THE INVENTION

This invention relates to a container having an opening, a lid pivotally mounted on the container and movable to open and close the opening, a lid latch assembly mounted on the lid and the lid latch assembly and container having cooperating engagement portions by which the lid can be held while closing the opening in the container.

### SUMMARY OF THE INVENTION

The present invention finds particular, but not exclusive, application to macerators which are used to reduce soiled waste products such as paper based bed pans so that they can be readily disposed of through the sewage system

An example of such a macerator is known from GB 2,445,036. When a load of soiled products has been macerated and discharged, further soiled products are introduced after opening a lid which, when closed, closes off the macerating chamber. The lid in this prior art macerator is mounted on a support arm pivotally mounted to the macerator which is biased to the open position by a spring at the pivot of the support arm.

The end of the support arm distal the pivot point has an inwardly turned catch which, in the closed position of the lid, catches on a latch. The lid is released by moving the latch out of engagement with the catch by a solenoid energised by means of a contactless switch, e.g. a foot interrupting an infra-red beam.

This provides that the lid is opened non-manually with the objective that the likelihood of transfer of pathogens to the macerator and onward transfer to other sites is reduced.

The present invention seeks to provide a container with a lid latch assembly which is electrically operable and which can also be manually opened if required or preferred.

Accordingly, the present invention provides a container having:

a housing defining an opening;

a lid pivotally mounted on the container and movable to open and close the opening;

a lid latch assembly mounted on the lid;

the lid latch assembly and container having cooperating engagement portions by which the lid can be held while the opening in the container is closed;

the lid latch assembly having a handle by which the lid can be manually pivoted to engage the cooperating engagement portions whilst storing energy in a spring in the lid latch assembly;

the handle being manually moveable to cause the cooperating engagement portions to disengage and so allow the lid to move to open the opening; and

an actuator which can be activated to cause the cooperating engagement portions to disengage under the action of the spring in which energy was stored on closing the lid.

The lid of the container can be opened manually by pushing the handle or by using the actuator.

According to first embodiment, the container may have a lid latch assembly comprising:

a support attached to the lid;

a lever arm pivotably mounted on the support and rotatable between a first position and a second position; and in which:

the spring is connected between the support and the lever arm and arranged to urge the lever arm to rotate from the first position to the second position;

the actuator is arranged to move a catch between a first catch position when the actuator is not activated and a second catch position when the actuator is activated and arranged such that the lever arm is held in the first position when the catch is in the first catch position and the lever arm is restrained from rotating further than the second position when the catch is in the second catch position;

the handle is pivotally mounted on the support and includes a latch roller which is part of the cooperating engagement portions, the handle being rotatable between a first position and a second position; and

a second spring arranged between the support and handle urging the handle to rotate from the first position to the second position;

the handle and lever arm being arranged such that the lever arm moves the handle to the second position when the lever arm rotates from the first position to second position and the handle moves the lever arm to the first position when the lever arm is manually rotated to the first position.

When the lid is held to close the opening the lever arm, catch and handle are all in their respective first positions. When the opening is opened using the actuator, the catch is moved to its second position, the lever consequently is moved to its second position by the spring and the handle moved to its second position and so disengage the cooperating engagement portions. Alternative the handle can simply be moved manually to its second position and so disengage the cooperating engagement portions.

According to first embodiment, the container may have a lid latch assembly comprising:

a support attached to the lid;

a latch stay pivotally mounted on the support and rotatable between a first position and a second position;

a latch plate pivotally mounted on the support and rotatable between a first position and a second position, the latch plate including a portion which forms part of the cooperating engagement portions;

the spring is connected between the latch stay and the latch plate and arranged to urge the latch plate to rotate from the first position to the second position and the latch stay to rotate from the second position to the first position;

the actuator is arranged to move the latch stay from the first position to the second position when activated;

the latch plate being prevented from rotating away from the first position when the latch stay is in the first position and rotatable to the second position when the latch stay in the second position;

the handle is pivotally mounted on the support and is rotatable between a first and a second position;

a second spring is arranged between the support and the handle urging the handle to rotate from the second position to the first position;

the handle, the latch plate and the latch plate being arranged such that the handle moves the latch plate to the first position when the handle is manually rotated to the first position and the handle moves the latch stay to the second position when the handle is manually rotated to the second position.

When the lid is held to close the opening the latch plate, latch stay and handle are all in their respective first positions. When the opening is opened using the actuator, the latch stay is moved to its second position, the latch plate consequently is moved to its second position by the spring and so disengage the cooperating engagement portions. Alternative the handle can simply be moved manually to its second position and so move the latch stay to second position whereupon the latch plate consequently is moved to its second position by the spring and so disengage the cooperating engagement portions.

The actuator may be an electrical solenoid, a micro geared motor drive or a pneumatic actuator, for example.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

Embodiments of the invention will now be described with reference to the accompanying drawings of which:

FIG. 1 is a perspective view of a container according a first embodiment to the present invention;

FIG. 2 is an isometric view of the lid latch assembly of the container of FIG. 1;

FIG. 3 is a top view of the lid latch assembly of the container of FIG. 2;

FIG. 4 is a side cross-section view of the lid latch assembly of the container of FIG. 3 on the line IV-IV of FIG. 3;

FIG. 5 is a top view of a lid latch assembly of container according a second embodiment to the present invention;

FIG. 6 is a side view of the lid latch assembly of FIG. 5;

FIG. 7 is an exploded perspective view of the lid latch assembly of FIG. 5; and

FIGS. 8 and 9 are sectional side views of the handle end of the lid latch assembly of FIG. 4 when the latch is in the open and closed, respectively.

### DETAILED DESCRIPTION OF THE INVENTION

A description of example embodiments of the invention follows.

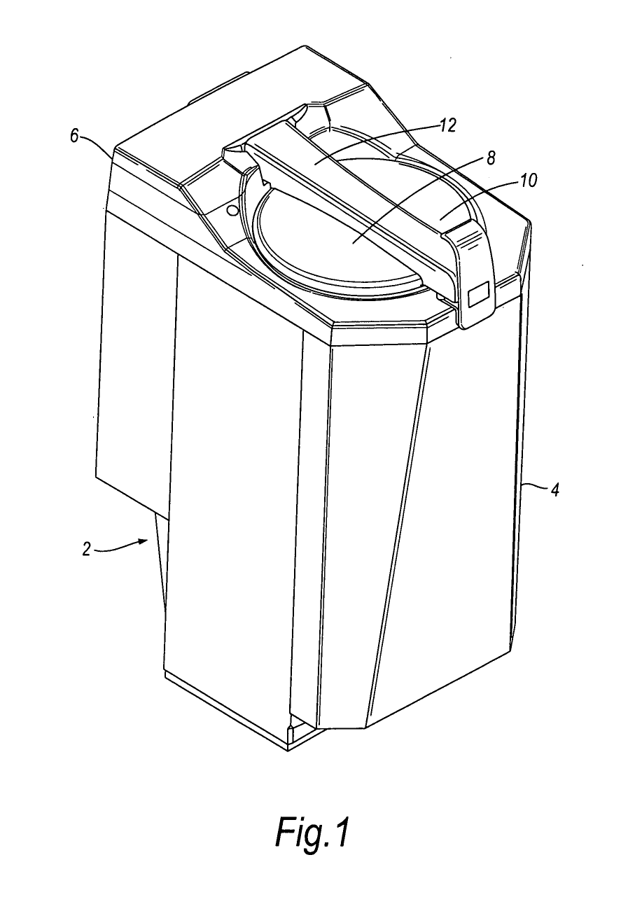

Referring to FIG. 1 a macerator 2 comprises a main body 4, a top cover 6 and a lid sub-assembly 8. The lid assembly 8 includes a circular lid 10 for sealing closed a macerator chamber (not shown) and a support beam 12 pivotally mounted to the top cover 6.

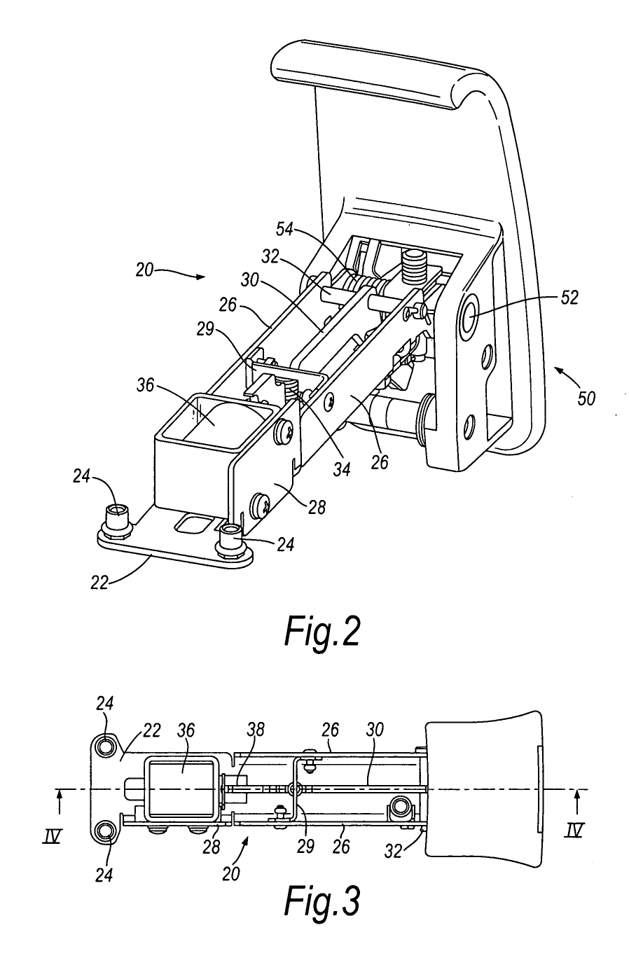

Mounted within the support beam 12 is a lid latch assembly as shown in FIGS. 2 to 4. It includes a latch mounting bracket 22 fixed to the lid assembly 8 by rivet nuts 24.

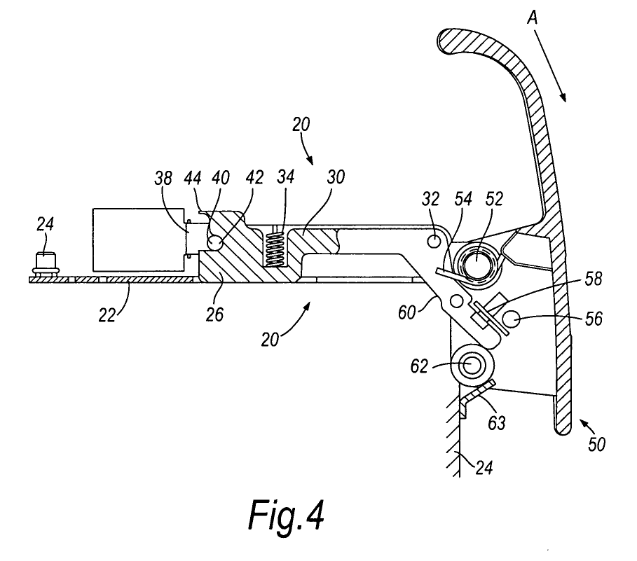

A pair of lever support plates 26, a solenoid mounting bracket 28 and a spring support plate 29 are attached to the bracket 22. A lever arm 30 is pivotally mounted on the lever support plates 26 at a pivot pin 32 and urged to rotate anti-clockwise by a spring 34 mounted on the spring support plate 29, as seen in the side view of FIG. 4.

A solenoid 36 is mounted on the solenoid mounting bracket 28 and has an arm 38 urged outwards by a light spring (not shown) in the non-activated condition and which is drawn towards the solenoid 36 in the activated condition. The arm 38 is slotted with the gap bridged by a solenoid roller 40 which engages with a camming track in the end of the lever arm 30.

In the position of FIG. 4, the lever arm 30 is at its most clockwise (first) position and the roller 40 is engaged with a locking detent 42 in the lever arm. On energising the solenoid 36 the arm 38 withdraws the roller 40 from the locking detent 42 which allows the lever arm 30 to pivot anti-clockwise under the action of the spring 34 until a finger 44 meets the roller 40 and the lever arm 30 is at its most anti-clockwise (second) position

Also pivotally mounted on the lever support plates 26 is a handle assembly 50 at a pivot pin 52 which is urged to rotate in an clockwise direction by a spring 54, as seen in the side view of FIG. 4. A pin 56 is fixed to the handle assembly 50 and which can contact an adjustable plate 58 mounted on a finger portion 60 of the lever arm 30 which extends downwardly and outwardly from the pivot 32 as shown in FIG. 4.

The handle assembly 50 also includes a roller latch 62 positioned to engage underneath a striker plate 63 mounted on the macerator's main body 4 and so hold the lid 10 in a closed position.

The lid latch assembly operates as follows. Pulling the handle assembly 50 downward and outward in the direction A as shown in FIG. 4 pivots the lid 10 downwards to close the macerator opening and the latch roller 62 rolls over the striker plate 63 on the macerator into engagement with it to latch the lid 10 in the closed position, the spring 54 urging the roller 62 to maintain the latched position. The action of pulling the handle assembly 50 in this manner urges the handle assembly to rotate clockwise about pivot pin 52 and causes pin 56 to push the lever arm 30 to its first position shown in FIG. 4 whilst compressing the spring 34. When the handle assembly 50 is released the detent 42 is engaged with the catch 38 which holds the lever arm 30 in position with the lid 10 held closed.

If the solenoid is now activated, for example by activating a contactless switch, the arm 38 is retracted along with the roller 40 and the lever arm 30 is free to rotate anticlockwise to its second position under the action of spring 34 until the finger 44 engages with the roller 40. The finger 60 of the lever arm 30 pushes against the pin 56 to rotate the handle assembly anti-clockwise to its second position so that the latch roller 62 rolls over the end of the striker plate and out of engagement with it. The spring loaded lid 10 is then free to lift and open the macerator 2.

Alternatively, the lid 10 can be unlatched by manually rotating the handle assembly anti-clockwise about the pivot pin 52 to similarly disengage the latch roller 62 to allow the lid 10 to lift and open the macerator 2.

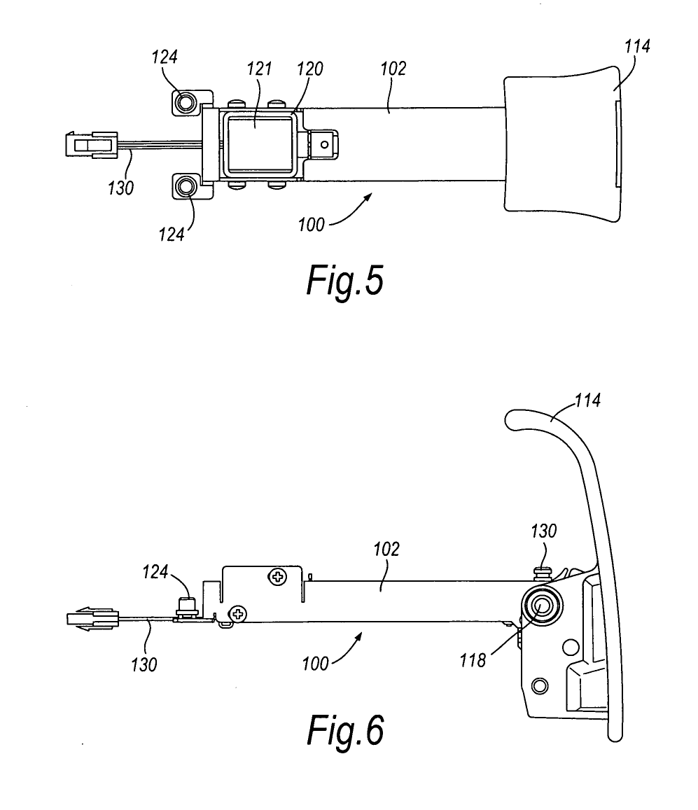

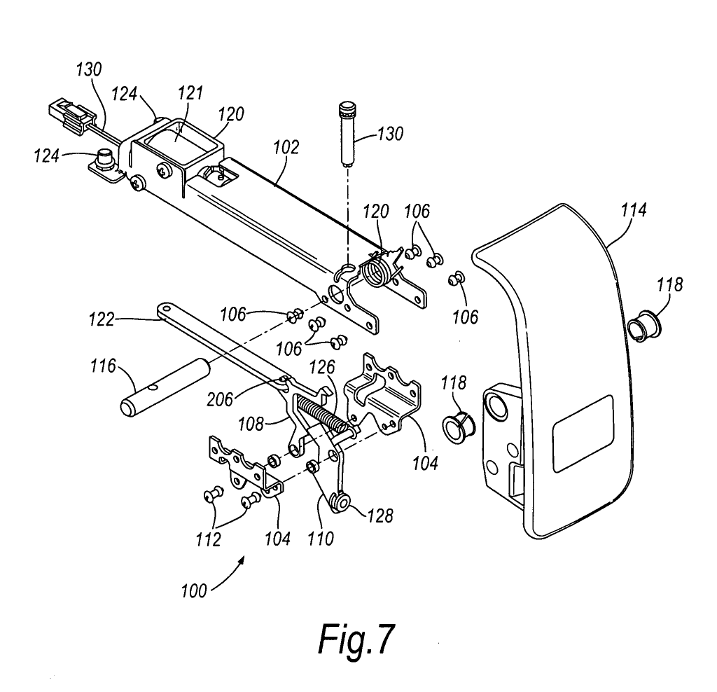

A second embodiment of the present invention is a container as in FIG. 1 with an alternative lid latch assembly 100 as shown in FIGS. 5 to 9.

A support plate 102 has attached to one end a pair of latch mounting brackets 104 by means of pop rivets 106 between which are pivotally mounted a latch stay 108 and a latch plate 110 each being mounted by means of a pop rivet 112. A handle 114 is also pivotally mounted on the support plate 102 on a lid catch fulcrum pin 116 and a pair of clip bearings 118. A torsion spring 120 with ends engaged with the support plate 102 and inside of the handle 114 acts to urge the handle 114 to rotate clockwise as viewed in FIGS. 6, 8 and 9.

A solenoid connector sub assembly 120 is mounted to the support plate 102 and includes a solenoid 121 coupled to one end of a link arm 122 the other end of the link arm being coupled to the latch stay 108.

The support plate 102 is fixed to the lid of the container (neither shown) by a pair of rivet 124. A tension spring 126 is fixed between the latch stay 108 and the latch plate 110. A grommet 128 provides a rubbing surface between the latch plate 110 and the

inside surface of the handle 114. An adjustment screw 130 controls how far the handle 114 can pivot relative to the support plate 102. A solenoid 121 is activated by applying a DC current via electrical leads 130.

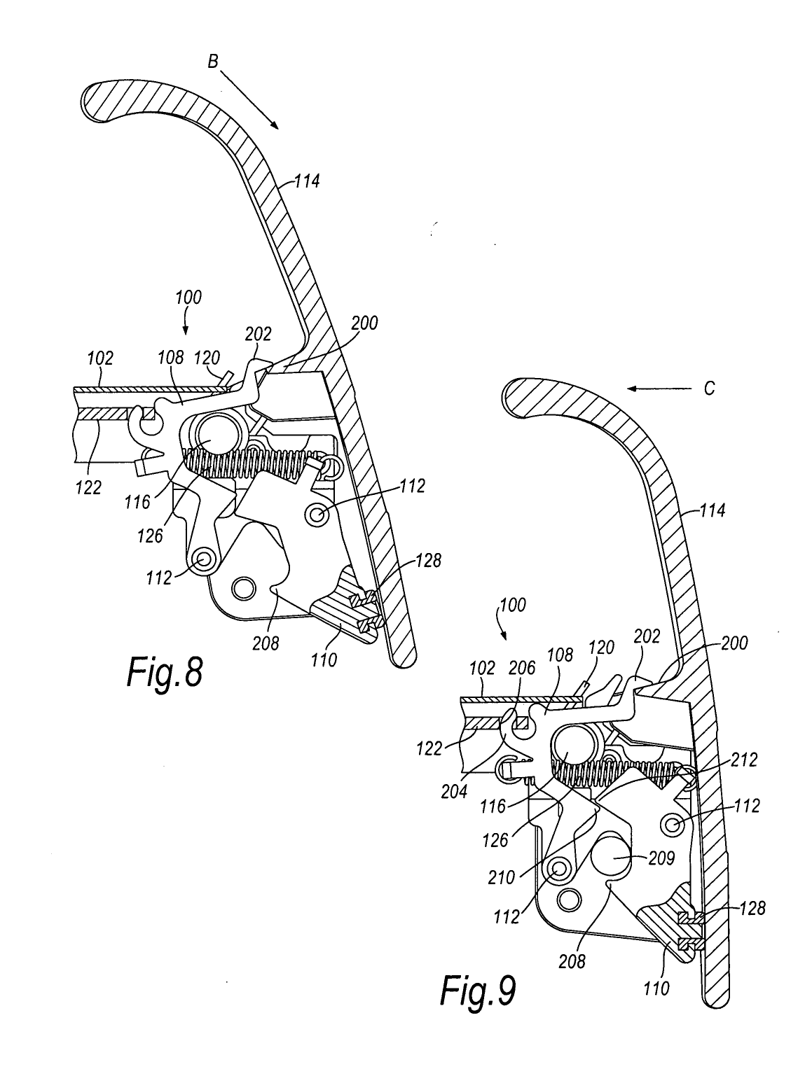

Referring now to FIGS. 8 and 9, the handle 114 has inwardly protruding ledge 200 which slidingly engages with a protrusion 202 at the end of the latch stay 108 opposite the pivot 112. The latch stay 108 is coupled to an end of link arm 122 by a C-shaped link 204 that lies within a through-hole 204 in the end of link arm 122.

The latch plate 110 has a claw 208 to engage with a bar 209 on the container 2 to latch the lid 10 in the closed position.

The embodiment of FIGS. 5 to 9 operates as follows. Assuming the lid 10 of the container 2 is raised, the lid latch assembly will be as shown in FIG. 8. if the top of the handle 114 is pulled downwardly and outwardly in the general direction B the lid 10 is pushed down to close the opening in the container and to cause the claw 208 of the latch plate 110 to engage with the bar 209 on the container and so latch the lid 10 in the closed position as shown in FIG. 9.

As the latch plate rotates clockwise about pivot 112 to latch the lid 10, so spring 126 acts to pivot the latch stay 108 clockwise so a portion 210 of it lies under a portion 212 of the latch plate to hold the latch plate 110 in the latched position of FIG. 9. The tension in the spring 126 will now be greater than in the earlier position as shown in FIG. 8.

The lid 8 can be opened in two ways: electrically and manually. On applying a suitable electrical voltage to the solenoid 121, the link arm 122 will be pulled to the left (as shown in FIG. 9) which causes the latch stay 108 to which it is connected to rotate anti-clockwise. Once the portion 210 of the latch stay 108 has moved sufficiently far, the latch plate 110 is free to rotate anti-clockwise under the action of the spring 126 so allowing the lid latch assembly 100 to move to the position shown in FIG. 8 at which point the lid 10 is free to pivot to the open position.

Alternatively, the top of the handle 114 can be pushed manually in the general direction C of FIG. 9 whereupon the ledge 200 pushes in a generally upward direction against the protrusion 202 of the latch stay 108 causing it to rotate anti-clockwise so unlatching the lid in the same manner as when opened by the solenoid 121.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A container having:
a housing defining an opening;
a lid pivotally mounted on the container and movable to open and close the opening;
a lid latch assembly mounted on the lid;
the lid latch assembly and container having cooperating engagement portions by which the lid can be held while the opening in the container is closed;
the lid latch assembly having a handle by which the lid can be manually pivoted to engage the cooperating engagement portions whilst storing energy in a spring in the lid latch assembly;
the handle being manually moveable to cause the cooperating engagement portions to disengage and so allow the lid to move to open the opening; and
an actuator which can be activated to cause the cooperating engagement portions to disengage under the action of the spring in which energy was stored on closing the lid.

2. A container as claimed in claim 1, the lid latch assembly comprising:
a support attached to the lid;
a lever arm pivotably mounted on the support and rotatable between a first position and a second position; and in which:
the spring is connected between the support and the lever arm and arranged to urge the lever arm to rotate from the first position to the second position;
the actuator is arranged to move a catch between a first catch position when the actuator is not activated and a second catch position when the actuator is activated and arranged such that the lever arm is held in the first position when the catch is in the first catch position and the lever arm is restrained from rotating further than the second position when the catch is in the second catch position;
the handle is pivotally mounted on the support and includes a latch roller which is part of the cooperating engagement portions, the handle being rotatable between a first position and a second position; and
a second spring arranged between the support and handle urging the handle to rotate from the first position to the second position;
the handle and lever arm being arranged such that the lever arm moves the handle to the second position when the lever arm rotates from the first position to second position and the handle moves the lever arm to the first position when the lever arm is manually rotated to the first position.

3. A container as claimed in claim 1, the lid latch assembly comprising:
a support attached to the lid;
a latch stay pivotally mounted on the support and rotatable between a first position and a second position;
a latch plate pivotally mounted on the support and rotatable between a first position and a second position, the latch plate including a portion which forms part of the cooperating engagement portions;
the spring is connected between the latch stay and the latch plate and arranged to urge the latch plate to rotate from the first position to the second position and the latch stay to rotate from the second position to the first position;
the actuator is arranged to move the latch stay from the first position to the second position when activated;
the latch plate being prevented from rotating away from the first position when the latch stay is in the first position and rotatable to the second position when the latch stay in the second position;
the handle is pivotally mounted on the support and is rotatable between a first and a second position;
a second spring is arranged between the support and the handle urging the handle to rotate from the second position to the first position;
the handle, the latch plate and the latch plate being arranged such that the handle moves the latch plate to the first position when the handle is manually rotated to the first position and the handle moves the latch stay to the second position when the handle is manually rotated to the second position.

4. A container as claimed in claim 1, in which the actuator is an electrical solenoid, a micro geared motor drive or a pneumatic actuator.

5. A container as claimed in claim 2, in which the actuator is an electrical solenoid, a micro geared motor drive or a pneumatic actuator.

6. A container as claimed in claim 3, in which the actuator is an electrical solenoid, a micro geared motor drive or a pneumatic actuator.
